(19) United States
(12) Patent Application Publication
(10) Pub. No.: US 2024/0011918 A1
(43) Pub. Date: Jan. 11, 2024

(54) INFORMATION PROCESSING APPARATUS, INFORMATION ACQUISITION APPARATUS OF ELASTIC BODY, INFORMATION ACQUISITION SYSTEM OF ELASTIC BODY, INFORMATION ACQUISITION METHOD OF ELASTIC BODY, AND NON-TRANSITORY STORAGE MEDIUM

(71) Applicant: KABUSHIKI KAISHA TOSHIBA, Tokyo (JP)

(72) Inventors: Takashi USUI, Saitama Saitama (JP); Hiroshi OHNO, Tokyo (JP)

(73) Assignee: KABUSHIKI KAISHA TOSHIBA, Tokyo (JP)

(21) Appl. No.: 18/176,326

(22) Filed: Feb. 28, 2023

(30) Foreign Application Priority Data
Jul. 11, 2022 (JP) 2022-111392

(51) Int. Cl. G01N 21/88; G01N 21/49; G01N 21/47

(52) U.S. Cl. CPC G01N 21/8851; G01N 21/49; G01N 21/4738

(57) ABSTRACT

According to an embodiment, an information processing apparatus includes a controller. The controller is configured to calculate a feature amount of a surface acoustic wave, based on direction information of a light ray that corresponds to gradient information of an elastic body surface of an inspection object that is obtained in a case where the surface acoustic wave is excited on the elastic body surface of the inspection object.

### CROSS-REFERENCE TO RELATED APPLICATIONS

This application is based upon and claims the benefit of priority from Japanese Patent Application No. 2022-111392, filed Jul. 11, 2022, the entire contents of all of which are incorporated herein by reference.

### FIELD

Embodiments described herein relate generally to an information processing apparatus, an information acquisition apparatus of an elastic body, an information acquisition system of an elastic body, an information acquisition method of an elastic body, and a non-transitory storage medium.

### BACKGROUND

A nondestructive inspection technique that uses waves (surface acoustic waves) transmitted along the surface or the boundary surface of a medium has attracted attention. It has been known that not only a surface flaw of the surface of an elastic body but also undersurface (e.g., subcapsular) damages, internal delamination, and the like of an elastic body are reflected in the property of surface acoustic waves excited on the elastic body. Because it is possible to control a penetration amount (penetration depth) from the surface of an elastic body to the inside thereof depending on the frequency at which surface acoustic waves are excited, by varying an excitation frequency, an inspection that focuses attention on an arbitrary depth can be conducted.

### BRIEF DESCRIPTION OF THE DRAWINGS

FIG. 1 is a schematic diagram illustrating an information acquisition system of an elastic body according to a first embodiment.

FIG. 2 is a schematic diagram illustrating a state of exciting surface acoustic waves on a surface of an inspection object via a wedge from an excitation element of a surface acoustic wave excitation portion of the information acquisition system of the elastic body that is illustrated in FIG. 1.

FIG. 3 is a schematic diagram illustrating a state in which a mode called a Lamb wave occurs when surface acoustic waves are excited on the surface of an inspection object in a case where the inspection object illustrated in FIG. 1 is a thin plate.

FIG. 4 is a schematic graph illustrating relationship between frequency and wavelength in appropriate material in a case where surface acoustic waves excited on the surface of the inspection object propagate as Lamb waves.

FIG. 5 is a flowchart illustrating a series of flows in a case where information regarding the elastic body is acquired using the information acquisition system of the elastic body.

FIG. 6 is a schematic diagram illustrating relationship between an example of an image (gradient information image) acquired using the information acquisition system of the elastic body, and surface acoustic waves.

FIG. 7 illustrates an example of various outputs obtained from the gradient information image illustrated in FIG. 6.

FIG. 8 illustrates an example of a defect detectable using the information acquisition system of the elastic body that is illustrated in FIG. 1.

FIG. 9 illustrates an example of a defect detectable using the information acquisition system of the elastic body that is illustrated in FIG. 1.

FIG. 10 illustrates an example of a thickness reduction detectable using the information acquisition system of the elastic body that is illustrated in FIG. 1.

FIG. 11 illustrates an example of a defect detectable using the information acquisition system of the elastic body that is illustrated in FIG. 1.

FIG. 12 is a schematic diagram illustrating an information acquisition system of an elastic body according to a modified example of the first embodiment.

FIG. 13 is a schematic diagram illustrating an information acquisition system of an elastic body according to a second embodiment.

FIG. 14 is a schematic diagram illustrating a propagation state of surface acoustic waves at a certain velocity in a case where an inspection object illustrated in FIG. 13 is liquid (water), and gas is air.

FIG. 15 is a schematic graph illustrating relationship between frequency and velocity that is obtained when liquid is water and gas is air, and a water depth is varied like 1 mm, 2 mm, 5 mm, 10 mm, and 20 mm.

FIG. 16 is a schematic graph illustrating relationship between frequency and wavelength that is obtained when liquid is water and gas is air, and a water depth is varied like 1 mm, 2 mm, 5 mm, 10 mm, and 20 mm.

FIG. 17 is a diagram illustrating an example of an excitation signal obtained by amplitude-modulating a sinusoidal wave with a carrier frequency of 200 kHz, at a predetermined modulation frequency.

FIG. 18 illustrates an example of a two-dimensional image obtained by capturing an image of a surface including an out-of-plane displacement of a surface acoustic wave that is caused in a case where the surface acoustic wave is excited at a modulation frequency of 30 Hz.

FIG. 19 illustrates an example of a three-dimensional image obtained by capturing an image of a surface including an out-of-plane displacement of a surface acoustic wave that is caused in a case where the surface acoustic wave is excited at a modulation frequency of 30 Hz.

FIG. 20 illustrates an example of a two-dimensional image obtained by capturing an image of a surface including an out-of-plane displacement of a surface acoustic wave that is caused in a case where the surface acoustic wave is excited at a modulation frequency of 40 Hz.

FIG. 21 illustrates an example of a three-dimensional image obtained by capturing an image of a surface including an out-of-plane displacement of a surface acoustic wave that is caused in a case where the surface acoustic wave is excited at a modulation frequency of 40 Hz.

### DETAILED DESCRIPTION

The problem to be solved by the present invention is to provide an information processing apparatus, an information acquisition apparatus of an elastic body, an information acquisition system of an elastic body, an information acquisition method of an elastic body, and a non-transitory storage medium storing an information acquisition program of an elastic body that can process or acquire information regarding an elastic body including a surface with an appropriate size, in a shorter time.

According to the embodiment, an information processing apparatus includes a controller. The controller is configured to calculate a feature amount of a surface acoustic wave, based on direction information of a light ray that corresponds to gradient information of an elastic body surface of an inspection object that is obtained in a case where the surface acoustic wave is excited on the elastic body surface of the inspection object.

Hereinafter, several embodiments will be described with reference to the drawings. The drawings are schematic or conceptual drawings, and relationship between the thickness and the width of each portion, a ratio in size between portions, and the like are not always the same as reality. In addition, even in a case where the same portion is illustrated, the portion is sometimes illustrated in different dimensions or ratios depending on the drawing. In the description of embodiments and in the drawings, an element similar to that described earlier with reference to an already-described drawing is assigned the same reference numeral, and the detailed description will be appropriately omitted.

In this specification, light is one type of electromagnetic waves, and is assumed to include X-rays, ultraviolet rays, visible light, infrared light, microwaves, and the like. In the present embodiment, light is assumed to be visible light, and a wavelength falls within a region from 450 nm to 700 nm, for example.

The inspection object O may be whichever of solid and liquid as long as the inspection object O is an elastic body. In addition, the inspection object O may be a substance form intermediate between solid and liquid (glass, gel, etc.). In a case where the inspection object O is solid, examples include metal, resin, concrete, and the like, but solid is not limited to these. Liquid can be water, various types of water solution, blood, and the like, but liquid is not limited to these.

A surface acoustic wave is a wave that propagates along an interface of a medium. The surface acoustic wave is accompanied by an out-of-plane displacement of an elastic body surface, and the type of restoring force of the elastic body is not limited. In a case where an object is solid, representative surface acoustic waves include a Rayleigh wave, a Lamb wave, and the like. In a case where the inspection object O is liquid, representative surface acoustic waves include a capillary wave, a gravitational wave, and the like depending on the type of restoring force, and whichever of these may be used.

### First Embodiment

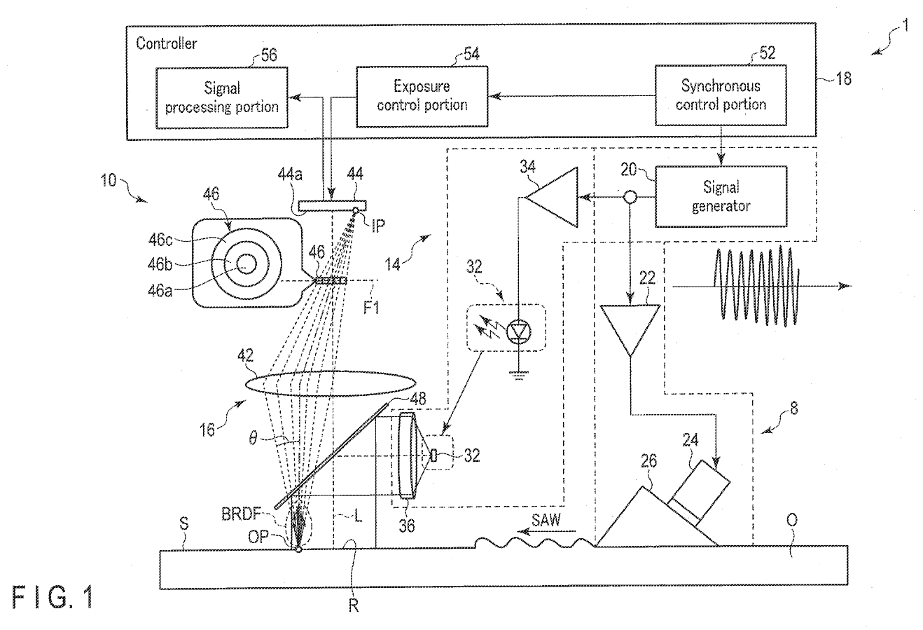

An information acquisition system (optical inspection system) 1 of an elastic body according to the first embodiment will be described using FIGS. 1 to 11. In the first embodiment, an example in which an inspection object O is a solid plate material such as a metal plate, for example, will be described. In the present embodiment, an example in which an aluminum alloy with a plate thickness of 1 mm is used as a metal plate will be described. In addition, here, reflective waves from an edge of the inspection object O are not considered.

FIG. 1 illustrates a schematic block diagram of the information acquisition system (optical inspection system) 1 of the elastic body according to the present embodiment.

As illustrated in FIG. 1, an information acquisition system 1 of the elastic body includes a surface acoustic wave excitation portion 8 that is configured to excite a surface acoustic wave (SAW) on a surface (elastic body surface) of the inspection object O, and an information acquisition apparatus 10 of the elastic body that is configured to acquire the surface acoustic wave excited by the surface acoustic wave excitation portion 8. The information acquisition apparatus 10 includes a light source portion 14 that is configured to illuminate the surface of the inspection object O, a gradient information acquisition portion 16 that is configured to acquire gradient information of a surface S of the inspection object O as an image, and a controller (information processing apparatus) 18 that is configured to control the surface acoustic wave excitation portion 8, the light source portion 14, and the gradient information acquisition portion 16.

In the present embodiment, the surface acoustic wave excitation portion 8 includes a signal generator (waveform generator) 20, an amplifier 22, and a surface acoustic wave excitation element 24.

The signal generator 20 is configured to output an appropriate signal such as a sinusoidal wave, a burst wave, or an amplitude-modulated wave in accordance with the inspection object O or an inspection method, for example.

The amplifier 22 is configured to amplify a voltage signal output from the signal generator 20, to a level at which the excitation element 24 is driven.

The excitation element 24 is formed as a piezoelectric element (transducer), a laser light source, a speaker, an electromagnetic acoustic wave element, or the like, for example. In the present embodiment, a case where the excitation element 24 is a piezoelectric element will be described.

In the present embodiment, the excitation element 24 is a piezoelectric element with a resonance frequency of 1 MHz, for example, and an acoustic emission (AE) sensor or the like can be used. An appropriate element can be used as the excitation element 24 as long as the element can excite a surface acoustic wave with an appropriate frequency.

By directly or indirectly inputting vibration to the surface (elastic body surface) S of the inspection object O, the excitation element 24 is configured to excite a surface acoustic wave on the elastic body surface S. In a case where the excitation element 24 is a piezoelectric element, the amplifier 22 is configured to amplify an amplitude of a signal to an amplitude equal to or larger than 50 Vpp, for example, or desirably to an amplitude equal to or larger than 150 Vpp, and input the signal to the excitation element 24.

The excitation element 24 can excite a surface acoustic wave on the surface of the inspection object O more efficiently via the wedge 26, for example. In this case, as the material of the wedge 26, it is necessary to use material having a sound velocity slower than a velocity of a Lamb wave, for example, as a surface acoustic wave to be excited. If the inspection object O on which a surface acoustic wave is excited is metal, it is preferable to use glass, resin, grease, liquid, or the like, for example, as the wedge 26.

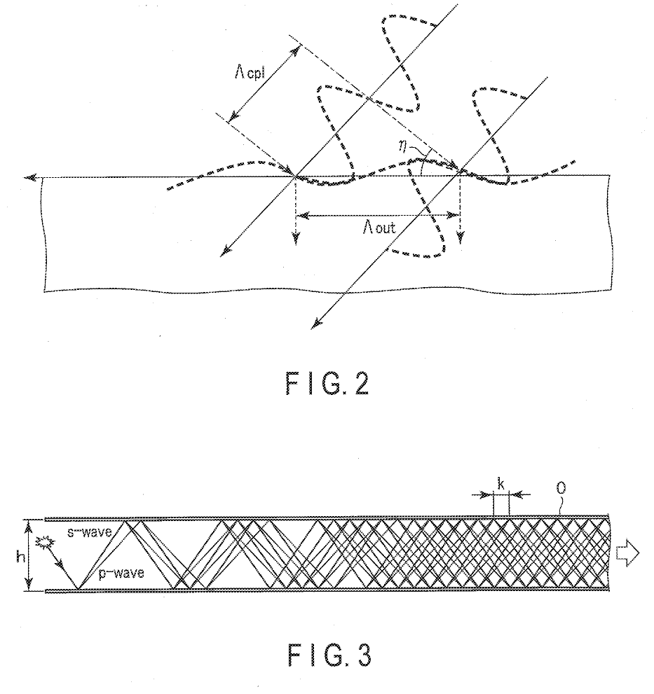

As illustrated in FIG. 2, if a wavelength in the wedge 26 is denoted by ∧_{cpi}, and a wavelength of a Lamb wave is denoted by ∧ₒᵤₜ, by a relationship of an angle θ formed by a wave surface in the wedge 26 and the surface (plane) of the inspection object O, satisfying relationships represented by the following formulae (1) and (2), it is possible to excite a surface acoustic wave on the surface S of the inspection object O most efficiently.

$${Λ}_{o u t} = \frac{{Λ}_{c ρ l}}{sin η} \qquad ( 1 )$$

$${C}_{o u t} = \frac{{c}_{c ρ l}}{sin η} \qquad ( 2 )$$

Note that C_{cpl} in Formula (2) denotes a velocity (sound velocity) of a surface acoustic wave excited in the wedge 26, and Cₒᵤₜ denotes a velocity (sound velocity) of a surface acoustic wave propagating in the inspection object O.

As illustrated in FIG. 1, the light source portion 14 includes a light source 32, a driver 34 for the light source 32, and an illumination lens 36.

A light-emitting diode (LED), for example, is used as the light source 32. Nevertheless, the light source 32 is not limited to this, and may be a halogen lamp, a xenon lamp, a laser light source, an X-ray light source, an infrared light source, or the like, and may be any a light source as long as the light source emits an electromagnetic wave being a wave including an electric field component and a magnetic field component.

Here, light emitted from an LED serving as a light source 32 is light having a component included in a wavelength spectral region from 400 nm to 850 nm.

The driver 34 for a light source 32 is configured to switch ON/OFF while controlling a timing of ON/OFF of the light source 32 in accordance with a signal from the signal generator 20. The signal generator 20 performs time-lag output of an output signal based on a signal of the synchronous control portion 52 to be described later. The signal generator 20 can adjust, for example, a timing at which a signal is input to the amplifier 22 and the excitation element 24 is driven, and a timing at which a signal is input to the driver 34 for the light source 32, which will be described later, and the light source 32 is caused to emit light, based on a signal from the synchronous control portion 52.

The illumination lens 36 can emit illumination light from the light source 32 toward the gradient information acquisition portion 16 as parallel light. The parallel light is emitted onto the surface S of the inspection object O via a beam splitter 48 of the gradient information acquisition portion 16, which will be described later. Thus, a region (illumination range) including an image capturing range R on the surface S of the inspection object O is illuminated with parallel light. In the present embodiment, the image capturing range R is assumed to be included in the illumination range.

Note that an appropriate optical system can be used as the light source portion 14 as long as the optical system can emit parallel light toward the beam splitter 48.

The gradient information acquisition portion 16 is configured to optically acquire a gradient distribution of the surface S of the inspection object O. The gradient information acquisition portion 16 can acquire gradient information at at least two different points (object points) of the inspection object O.

The gradient information acquisition portion 16 includes an image formation optical system 42, an image sensor 44 including a light receiving portion 44a, a multiwavelength aperture (diaphragm) 46, and the beam splitter 48.

The image formation optical system 42 exists at a position facing the inspection object O. FIG. 1 schematically illustrates the image formation optical system 42 as a single lens, but the image formation optical system 42 may be a coupling lens. In the present embodiment, for the sake of simplification, the image formation optical system 42 is assumed to be a single lens. The image formation optical system 42 may be any optical element as long as the optical element includes a function of condensing light rays emitted from one point of an object (i.e., object point OP), to a conjugate image point IP on the light receiving portion 44a of the image sensor 44.

The image sensor 44 includes, in each pixel, a plurality of color channels that disperses at least two mutually-different wavelengths. Normally, the image sensor 44 includes, in each pixel, an R channel, a G channel, and a B channel. Thus, the image sensor 44 can acquire a color image, and disperse three mutually-different wavelengths. In addition, the R channel, the G channel, and the B channel in each pixel can output pixel values. A pixel value is represented by a 256-level grayscale from 0 to 255, for example. As described later, a pixel value is acquired by the gradient information acquisition portion 16.

The image sensor 44 is configured to capture an image of light having passed through the image formation optical system 42. Thus, the light receiving portion 44a of the image sensor 44 exists on an optical axis of the image formation optical system 42. For example, a complementary metal-oxide semiconductor (CMOS) area sensor is used as the image sensor 44. Nevertheless, the image sensor 44 is not limited to this, and may be a charge-coupled device (CCD) area sensor, or may be a line sensor. A hyperspectral camera may be used as the image sensor 44. That is, the image sensor 44 may be any sensor as long as the sensor sense light emitted from the light source 32 of the light source portion 14.

The image sensor 44 can disperse, in each pixel, a first wavelength (light in a first wavelength region), a second wavelength (light in a second wavelength region), and a third wavelength (light in a third wavelength region), for example, separate into colors of RGB.

The multiwavelength aperture 46 is arranged on an optical axis of the image formation optical system 42. The multiwavelength aperture 46 is arranged between the image formation optical system 42 and the image sensor 44. The multiwavelength aperture 46 is arranged on a focal plane F1 of the image formation optical system 42, or arranged near the focal plane F1.

In the present embodiment, the multiwavelength aperture 46 is formed into a disk shape, for example, and is formed to be rotationally symmetric. Note that the multiwavelength aperture 46 may be formed into an appropriate shape such as a rectangular shape or an ellipsoidal shape. In a case where a line sensor is used as the image sensor 44, the multiwavelength aperture 46 may have a belt-like shape extending parallel to a sheet surface, or in a direction orthogonal to the sheet surface, for example, in accordance with the orientation of the line sensor.

In the present embodiment, the multiwavelength aperture 46 includes a first wavelength selection region 46a that is configured to pass through light rays in a first wavelength and a wavelength near the first wavelength, at a central part, a second wavelength selection region 46b that is provided in the outer periphery of the first wavelength selection region 46a, and is configured to pass through light rays in a second wavelength and a wavelength near the second wavelength, and a third wavelength selection region 46c that is provided in the outer periphery of the second wavelength selection region 46b, and is configured to pass through light rays in a third wavelength and a wavelength near the third wavelength.

The first wavelength, the second wavelength, and the third wavelength each include an appropriate range (i.e., first wavelength range and second wavelength range), but it is preferable that wavelengths do not overlap. Thus, in the present embodiment, the first wavelength range, the second wavelength range, and the third wavelength range are independent.

In the present embodiment, the first wavelength selection region 46a passes through blue (B)—color light, for example, (i.e., light in a wavelength of 450 nm and a wavelength near 450 nm, for example). The first wavelength selection region 46a blocks light in a wavelength different from a wavelength of 450 nm and a wavelength near 450 nm, for example.

The second wavelength selection region 46b passes through green (G)—color light, for example, (i.e., light in a wavelength of 530 nm and a wavelength near 530 nm, for example). The second wavelength selection region 46b blocks light in a wavelength different from a wavelength of 530 nm and a wavelength near 530 nm, for example.

The third wavelength selection region 46c passes through red (R)—color light, for example, (i.e., light in a wavelength of 650 nm and a wavelength near 650 nm, for example). The third wavelength selection region 46c blocks light in a wavelength different from a wavelength of 650 nm and a wavelength near 650 nm, for example.

Specularly-reflected light from the object point OP existing inside the image capturing range R of the surface S of the inspection object O (light parallel to an optical axis L) (i.e., light with a first angle θ≈0° with respect to the optical axis L) passes through the first wavelength selection region 46a and enters the image point IP of the light receiving portion 44a of the image sensor 44 via the image formation optical system 42. At this time, among light rays reflected from the object point OP toward the image sensor 44, light in a wavelength deviating from the first wavelength (i.e., light in a wavelength deviating from 450 nm and a wavelength near 450 nm) is blocked by the first wavelength selection region 46a. The first wavelength selection region 46a passes through blue (B) light in a wavelength of 450 nm and a wavelength near 450 nm. Accordingly, at the image point IP of the image sensor 44, light having passed through the first wavelength selection region 46a is acquired as blue (B) light.

Scattering light from the object point OP on the surface S of the inspection object O that has a second angle θ2 (>01) (not parallel to the optical axis L) passes through the second wavelength selection region 46b and enters the image point IP of the light receiving portion 44a of the image sensor 44 via the image formation optical system 42. At this time, among light rays reflected from the object point OP toward the image sensor 44, light in a wavelength deviating from the second wavelength (i.e., light in a wavelength deviating from 530 nm and a wavelength near 530 nm) is blocked by the second wavelength selection region 46b. The second wavelength selection region 46b passes through green (G) light in a wavelength of 530 nm and a wavelength near 530 nm. Accordingly, at the image point IP of the image sensor 44, light having passed through the second wavelength selection region 46b is acquired as green (G) light.

Scattering light from the object point OP on the surface S of the inspection object O that has a third angle θ3 (>θ2) (not parallel to the optical axis L) passes through the third wavelength selection region 46c and enters the image point IP of the light receiving portion 44a of the image sensor 44 via the image formation optical system 42. At this time, among light rays reflected from the object point OP toward the image sensor 44, light in a wavelength deviating from the third wavelength (i.e., light in a wavelength deviating from 650 nm and a wavelength near 650 nm) is blocked by the third wavelength selection region 46c. The third wavelength selection region 46c passes through red (R) light in a wavelength of 650 nm and a wavelength near 650 nm. Accordingly, at the image point IP of the image sensor 44, light having passed through the third wavelength selection region 46c is acquired as red (R) light.

According to the aforementioned gradient information acquisition portion 16, an image of a certain object point OP is received at the image point IP of the light receiving portion 44a of the image sensor 44. Thus, if the certain object point OP is formed as a plane orthogonal to the optical axis L, an image of specularly-reflected light (here, blue light) is formed at the image point IP. In a case where unevenness is formed at the certain object point OP, an image of scattering light (here, green light and/or red light) is formed at the image point IP. Accordingly, by arranging the multiwavelength aperture 46 on the focal plane F1 of the image formation optical system 42, an image acquired in each pixel of the light receiving portion 44a of the image sensor 44 can be colored in accordance with a direction of a light ray from the object point OP (specularly-reflected light, scattering light). That is, the gradient information acquisition portion 16 optically acquires direction information of light rays that corresponds to gradient information of the elastic body surface S.

A direction distribution of reflected light from the object point OP on the surface S of the inspection object O can be represented by a distribution function called bidirectional reflectance distribution function (BRDF). The BRDF generally changes depending on the surface property and the shape of the surface S of the inspection object O. In other words, the BRDF changes depending on the surface state of the surface S of the inspection object O. For example, because reflected light spreads in various directions if the surface S is rough, the BRDF becomes a wide distribution. In other words, reflected light exists over a wide angle. On the other hand, if the surface S becomes a specular surface, reflected light includes almost only specular reflection components, and the BRDF becomes a narrow distribution. In this manner, the BRDF reflects the surface property and the shape of the surface S of the inspection object O. Here, the surface property and the shape may be surface roughness, may be micron-size minute unevenness, may be the gradient of the surface, or may be distortion or the like. In other words, the surface property and the shape may be anything as long as the surface property and the shape are related to a height distribution of the surface. In a case where the surface property and the shape have a minute structure, a typical structural scale thereof may be a nanoscale, may be a micronscale, may be a milliscale, or may be any scale.

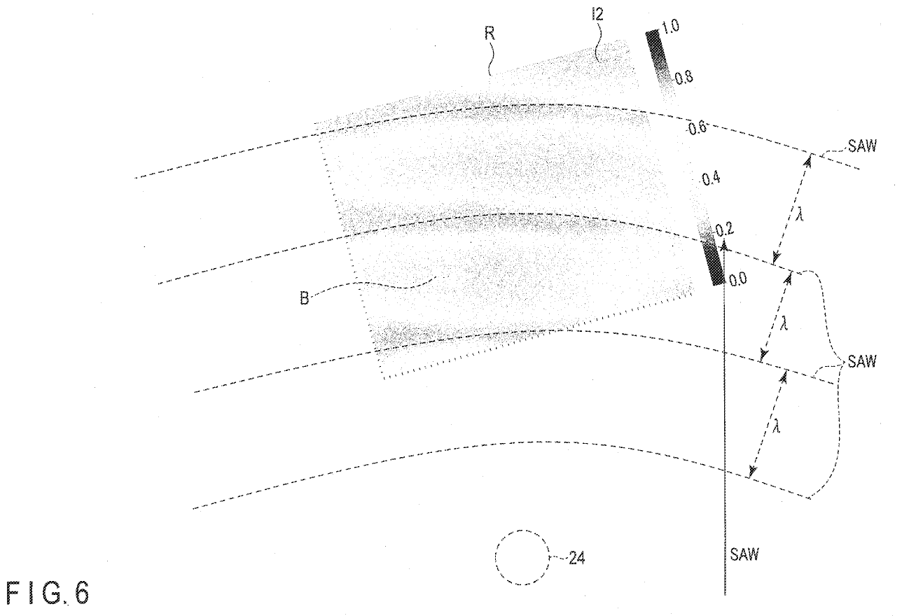

The number of pixels in an image captured by the light receiving portion 44a of the image sensor 44 is n×m (n and m are integers equal to or larger than 3). Thus, an image from each object point OP inside the image capturing range R is acquired through each pixel of the light receiving portion 44a of the image sensor 44 at the same time, and one gradient image I (refer to FIG. 6) is acquired.

An image of the object point OP in a region in which no flaw exists on the surface S of the inspection object O is captured by the light receiving portion 44a of the image sensor 44 as specularly-reflected light.

Here, the second angle θ2 at which reflected light from the object point OP passes through the second wavelength selection region 46b is larger than the first angle θ1 (≈0°) at which the reflected light passes through the first wavelength selection region 46a. In addition, the third angle θ3 at which reflected light from the object point OP passes through the third wavelength selection region 46c is larger than the second angle θ2 at which the reflected light passes through the second wavelength selection region 46b. In this manner, by arranging the multiwavelength aperture 46 on the focal plane F1 of the image formation optical system 42, an image acquired by the image sensor 44 can be colored in accordance with the direction of a light ray from the surface S of the inspection object O (specularly-reflected light, scattering light).

Then, the gradient information acquisition portion 16 can acquire the intensity (pixel value) of light in each wavelength that has been image-captured by the image sensor 44. A signal processing portion 56 of the controller 18 can calculate a deflection angle of light for each wavelength based on the intensity of light in each wavelength.

The beam splitter 48 is drawn into a plate shape in FIG. 1, but may have a cube shape or the like, for example. A half mirror having an approximately-same amount as a transmitted light amount and a reflected light amount may be used as the beam splitter 48.

The controller 18 is configured to control the surface acoustic wave excitation portion 8 and the information acquisition apparatus 10 (the light source portion 14 and the gradient information acquisition portion 16).

The controller 18 includes a computer or the like, for example, and includes a processor (processing circuit) and a storage medium. The processor includes any of a central processing unit (CPU), an application specific integrated circuit (ASIC), a microcomputer, a field programmable gate array (FPGA) and a digital signal processor (DSP), and the like. The storage medium can include an auxiliary storage device in addition to a main storage device such as a memory. Examples of storage media include a nonvolatile memory into and from which writing and readout can be performed as necessary, such as a hard disk drive (HDD), a solid state drive (SSD), a magnetic disk, an optical disk (CD-ROM, CD-R, DVD, or the like), a magneto-optical disk (MO, or the like), and a semiconductor memory.

In the controller 18, only one processor and only one storage medium may be provided, or a plurality of processors and a plurality of storage media may be provided. In the controller 18, the processor performs processing by executing a program or the like that is stored in a storage medium or the like. In addition, a program to be executed by the processor of the controller 18 may be stored in a computer (server) connected to the controller 18 via a network such as the Internet, a server in a cloud environment, or the like. In this case, the processor downloads a program via a network. The controller 18 executes adjustment of an excitation timing of the excitation element 24, an exposure timing of the image sensor 44, and a light emission timing (light illumination timing) of the light source 32 of the light source portion 14. In addition, in the controller 18, the processor or the like executes image acquisition from the image sensor 44, and various types of calculation processing that are based on an image acquired from the image sensor 44, and the storage medium is caused to function as a data storage medium.

In addition, at least part of processing to be executed by the controller 18 may be executed by a cloud server constructed in a cloud environment. An infrastructure in a cloud environment includes a virtual processor such as a virtual CPU, or the like, and a cloud memory. In a certain example, the virtual processor executes image acquisition from the image sensor 44, and various types of calculation processing that are based on an image acquired from the image sensor 44, and the cloud memory functions as a data storage medium.

The controller 18 includes the synchronous control portion 52, an exposure control portion 54, and the signal processing portion (image processing apparatus) 56.

The exposure control portion 54 is configured to control an exposure time (exposure timing) of the light receiving portion 44a of the image sensor 44. The synchronous control portion 52 is configured to control a timing at which a signal is input to the excitation element 24 from the signal generator 20 through the amplifier 22, a timing at which the light source 32 is caused to emit light, via the driver 34 for a light source, and a timing at which the image sensor 44 is exposed via the exposure control portion 54. That is, the synchronous control portion 52 is configured to output operation timings of the image sensor 44 (the exposure control portion 54) and the light source portion 14, and the surface acoustic wave excitation portion 8. This is to consider a propagation time for which a surface acoustic wave propagates, based on a distance from an input position of the surface acoustic wave on the surface S of the inspection object O to the image capturing range R.

Note that the exposure control portion 54 may be used for the control of light emission of the light source 32 of the light source portion 14 as an exposure/illumination control portion.

The signal processing portion 56 is configured to extract a feature amount of a surface acoustic wave by processing gradient information acquired by the image sensor 44 of the gradient information acquisition portion 16.

The processor (controller 18) includes a function as the signal processing portion (image processing portion) 56 for image data of an image captured by the image sensor 44. The processor is configured to calculate gradient information related to the inspection object O, based on image data output of the image sensor 44. Note that image data of an image captured by the image sensor 44 is output from at least two or more pixels.

For example, a storage medium stores various programs. The processor fulfills functions complying with programs, by writing various programs stored in a storage medium, for example, into a RAM and executing the programs.

The various programs need not be always stored in the storage medium, and the processor can execute the various programs on a server via a network.

The storage unit is a nonvolatile memory such as an HDD or an SSD, for example, but may further include a volatile memory. For example, a cloud memory may be used as a storage medium. For example, an information acquisition program (optical inspection program) or an algorithm of an elastic body according to the present embodiment, and a signal processing program corresponding to a setting of the gradient information acquisition portion 16 (a setting of the multiwavelength aperture 46 with respect to the optical axis L) are stored in the storage medium. The information acquisition program of an elastic body and the signal processing program may be stored in a ROM.

The information acquisition program of an elastic body may be preinstalled on the information acquisition system 1 of an elastic body, or may be stored in a nonvolatile storage medium, or delivered via a network. The information acquisition program of an elastic body may be provided on the outside of the information acquisition system 1 of an elastic body, such as an appropriate server, for example.

Here, a theoretical background of a surface acoustic wave will be described. Here, a dominant equation in an elastic wave theory will be considered. A displacement vector u can be represented by the following formulae (3) and (4) using the Helmholtz's theorem.

u=V̅Φ+V̅×Ψ (3)

V̅Ψ=0 (4)

A motion equation can be represented in the form of the following formula (5) using constants unique to material Lamé's constants λ, μ, density ρ).

$$( λ + μ ) ∇ ( ∇ \cdot u ) + {μ V}^{2} u = ρ \frac{{\partial }^{2} u}{\partial {t}^{2}} \qquad ( 5 )$$

By the above formulae, the following two independent wave motion equations (6) and (7) can be derived.

$${∇}^{2} Φ - \frac{1}{{C}_{L}^{2}} \frac{{\partial }^{2}}{\partial {t}^{2}} Φ = 0 \qquad ( 6 )$$

$${∇}^{2} Ψ - \frac{1}{{C}_{T}^{2}} ∇ \frac{{\partial }^{2}}{\partial {t}^{2}} Ψ = 0 \qquad ( 7 )$$

The respective propagation velocities can be represented by the following formulae (8) and (9).

$${C}_{T} = \sqrt{\frac{λ}{ρ}} = {C}_{s} \qquad ( 8 )$$

$${C}_{L} = \sqrt{\frac{λ + 2 μ}{ρ}} = {C}_{p} \qquad ( 9 )$$

In each formula, C_{L} denotes a longitudinal wave and C_{T} denotes a transverse wave. Furthermore, as illustrated in FIG. 3, in a case where material is a thin plate, the longitudinal wave and the transverse wave are mutually converted at the boundary, and a synthetic wave satisfying a predetermined phase condition is observed as a traveling wave with a certain wavenumber, and a mode called the Lamb wave occurs. If the plate thickness of the material is assumed to be infinite, a dispersion relationship of the Rayleigh wave is obtained.

If a boundary condition is set with a thickness direction Z=±h/2, a frequency ω and a wavenumber k satisfy relationships of the following formulae (10) to (12), which are known as Rayleigh-Lamb equations.

$$\frac{tan ( p h / 2 )}{tan ( q h / 2 )} = {( \frac{{( {k}^{2} - {q}^{2} )}^{2}}{4 {k}^{2} p q} )}^{\pm 1} \qquad ( 10 )$$

$$p = \sqrt{\frac{{ω}^{2}}{{C}_{p}} - {k}^{2}} \qquad ( 11 )$$

$$q = \sqrt{\frac{{ω}^{2}}{{C}_{s}} - {k}^{2}} \qquad ( 12 )$$

In FIG. 3, a p-wave and an s-wave are generated at reflection points on the top surface and the bottom surface of a plate. Then, the synthesis of the p-wave and the s-wave satisfying a predetermined phase condition becomes a Lamb wave that looks like a traveling wave with the wavenumber k.

A phase velocity vₚ and a group velocity v_{g} of the Lamb wave can be obtained from a velocity dispersion relationship represented by the following formulae (13) and (14).

$${v}_{ρ} = \frac{ω}{k} \qquad ( 13 )$$

$${v}_{g} = \frac{δ ω}{δ k} \qquad ( 14 )$$

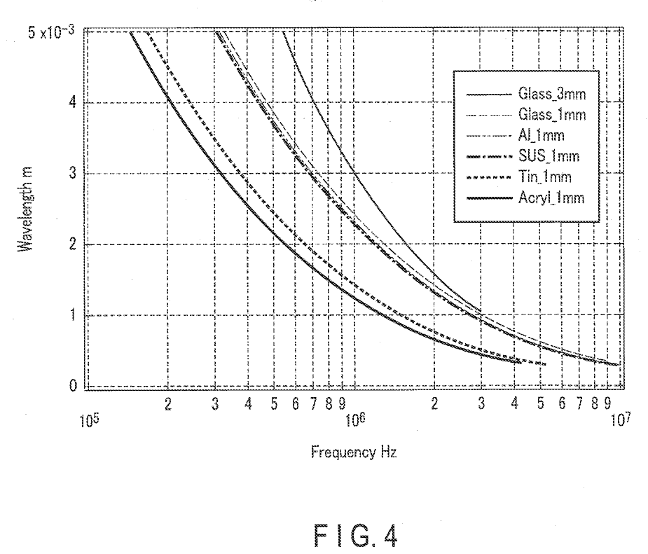

Accordingly, a relationship between the frequency f, the phase velocity vₚ, and the group velocity v_{g} can be obtained. That is, a velocity and a wavelength can be obtained based on values unique to material, parameters of the shape (thickness in this case), and a frequency. As an example, FIG. 4 illustrates a calculation example in which relationship between frequency and wavelength is obtained for 1-mm thickness glass, 3-mm thickness glass, 1-mm thickness aluminum, 1-mm thickness SUU, 1-mm thickness tin, and 1-mm thickness acryl.

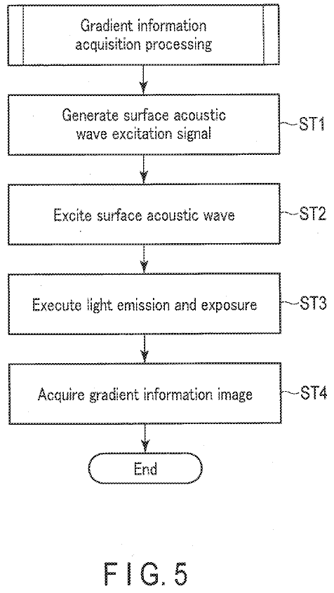

Next, an acquisition method of surface acoustic wave information that is to be used by the information acquisition system 1 of an elastic body will be described using a flowchart illustrated in FIG. 5.

First of all, as mentioned above, the inspection object O is an aluminum plate and a plate thickness is 1 mm, for example. The excitation element 24 of the surface acoustic wave excitation portion 8 is a piezoelectric element with a resonance frequency of 1 MHz.

Then, the controller 18 generates a sinusoidal wave with a frequency of 1 MHz, for example (refer to FIG. 1), using an arbitrary waveform generator of the signal generator (waveform generator) 20 (Step ST1). The amplifier 22 of the surface acoustic wave excitation portion 8 amplifies voltage to 50 to 150 times, and applies the voltage to the excitation element 24. Thus, the excitation element 24 vibrates, and a surface acoustic wave with a frequency of 1 MHz is excited on the aluminum plate being the inspection object O (Step ST2).

Here, the excitation element 24 can excite a surface acoustic wave on the surface S of the inspection object O most efficiently via the wedge 26.

Note that, according to the theory of the Lamb wave, if a surface acoustic wave with a frequency of 1 MHz is excited on the aluminum plate being the inspection object O, as illustrated in FIG. 4, the wavelength λ of the excited surface acoustic wave can be estimated to be 5 mm or less.

Note that the propagation velocity of the surface acoustic wave is propagation velocity=frequency×wavelength, and a position at which excitation vibration is input from the excitation element 24 via the wedge 26 is identified. Thus, a time taken for the surface acoustic wave reaching the image capturing range R from an excitation position at which the excitation element 24 inputs vibration to the inspection object O and excites the surface acoustic wave is known to some extent.

Thus, the synchronous control portion 52 controls the driver 34 for the light source 32 and causes the light source 32 to emit light, during a period from the time when excitation vibration is input to the surface S of the inspection object O from the excitation element 24 via the wedge 26, to the time when the surface acoustic wave reaches the image capturing range R. In addition, the synchronous control portion 52 controls the exposure control portion 54, and starts exposure of the image sensor 44 during a period from the time when excitation vibration is input to the surface S of the inspection object O from the excitation element 24 via the wedge 26, to the time when the surface acoustic wave reaches the image capturing range R (Step ST3).

That is, the synchronous control portion 52 outputs an excitation start signal for commanding a start timing of an excitation operation of the surface acoustic wave excitation portion 8, and an exposure/illumination start signal commanding a timing at which the exposure control portion 54 starts exposure of the image sensor 44, and illumination of the elastic body surface S with parallel light. A time lag between the excitation start signal and the exposure/illumination start signal can be determined based on a distance from a position of a surface acoustic wave at which the surface acoustic wave is initially excited by the excitation element 24 on the inspection object O, to a central part, for example, of the image capturing range R on the surface S of the inspection object O that is to be image-captured by the gradient information acquisition portion 16. That is, the synchronous control portion 52 outputs the excitation start signal and the exposure/illumination start signal with a predetermined time lag that is based on the propagation velocity of the surface acoustic wave.

The light source 32 emits illumination light toward the beam splitter 48 via the illumination lens 36. Illumination light emitted from the light source 32 is emitted onto the surface S of the inspection object O via the beam splitter 48 as parallel light. Then, illumination light is reflected on the surface S of the inspection object O.

Here, the reflection is used in the meaning including scattering and specular reflection. Hereinafter, the reflection has similar meaning unless otherwise specified.

Among specularly-reflected light rays, an image of light in the first wavelength and a wavelength near the first wavelength is formed on the light receiving portion 44a of the image sensor 44 through the image formation optical system 42, and the first wavelength selection region 46a of the multiwavelength aperture 46.

Among reflected light rays, among light rays scattering within a range of the second scattering angle (second reflection angle) 02 with respect to the optical axis, an image of light in the second wavelength and a wavelength near the second wavelength is formed on the light receiving portion 44a of the image sensor 44 through the image formation optical system 42, and the second wavelength selection region 46b of the multiwavelength aperture 46.

Among reflected light rays, among light rays scattering within a range of the third scattering angle (third reflection angle) 03 with respect to the optical axis, an image of light in the third wavelength and a wavelength near the third wavelength is formed on the light receiving portion 44a of the image sensor 44 through the image formation optical system 42, and the third wavelength selection region 46c of the multiwavelength aperture 46.

Here, the second scattering angle θ2 and the third scattering angle θ3 are assumed to correspond to an angle formed by two light rays including an incident light ray of illumination light onto the surface S of the inspection object O, and a reflected light ray from the surface S of the inspection object O, and assumed to be 90° or less.

Thus, the image sensor 44 acquires an image related to gradient information of an image capturing range, and outputs image information to the signal processing portion 56 (Step ST4). Accordingly, the gradient information acquisition portion 16 can optically acquire, as an image, gradient information of an elastic body colored in accordance with a direction of a light ray from the object point OP on the elastic body surface S of the inspection object O that includes information regarding an out-of-plane displacement of the elastic body surface S that is caused by exciting a surface acoustic wave on the elastic body surface S of the inspection object O by the surface acoustic wave excitation portion 8. That is, the signal processing portion 56 acquires direction information of light rays associated with colors.

Note that light in the first wavelength and a wavelength near the first wavelength, light in the second wavelength and a wavelength in the second wavelength, and light in the third wavelength and a wavelength near the third wavelength have wavelengths not overlapping each other. Thus, images of light in the first wavelength and a wavelength near the first wavelength, light in the second wavelength and a wavelength in the second wavelength, and light in the third wavelength and a wavelength near the third wavelength are captured by color separation in each pixel of the light receiving portion 44a of the image sensor 44.

Light in the first wavelength and a wavelength near the first wavelength is blue (B) in the present embodiment. Light in the second wavelength and a wavelength near the second wavelength is green (G) in the present embodiment. Light in the third wavelength and a wavelength near the third wavelength is red (R) in the present embodiment.

In a case where a wavelength of a surface acoustic wave to be excited by the excitation element 24 of the surface acoustic wave excitation portion 8 is denoted by A, and a cycle is denoted by T, the light receiving portion 44a of the image sensor 44 of the gradient information acquisition portion 16 illustrated in FIG. 1 sets the image capturing range R with a circular region having at least a diameter λ or more, on the elastic body surface S. Thus, the light receiving portion 44a of the image sensor 44 can surely capture surface acoustic waves within the image capturing range R.

Then, the synchronous control portion 52 stops light emission of the light source 32 while a surface acoustic wave is passing through the image capturing range R, or after the surface acoustic wave has passed through the image capturing range R. In addition, the synchronous control portion 52 controls the exposure control portion 54, and stops exposure of the image sensor 44 while a surface acoustic wave is passing through the image capturing range R, or after the surface acoustic wave has passed through the image capturing range R.

Note that the exposure control portion 54 controls an exposure start timing and an exposure time of the gradient information acquisition portion 16 for the image sensor 44. A light emission time (i.e., exposure time tₑₓₚ) of the light source 32 is predetermined based on the frequency f of the surface acoustic wave to be excited, in such a manner as to satisfy the relationship represented by the following formula (15).

tₑₓₚ<1/f·½ (15)

Note that, if the light emission time desirably satisfies the relationship represented by Formula (16), the light receiving portion 44a of the image sensor 44 can acquire a clearer signal (gradient information image).

tₑₓₚ<1/f· 1/10 (16)

The exposure time tₑₓₚ is a time at which an open time of a shutter of the image sensor 44 and an illumination time of the light source 32 match. Either or both of a shutter velocity of the image sensor 44 and an illumination time of the light source 32 are to be controlled by the controller 18.

Note that, for example, exposure time tₑₓₚ-0.1 e⁻⁶[s] is set in such a manner as to satisfy Formula (17) in a case where a frequency of a surface acoustic wave to be excited is frequency f=1 MHz.

$${t}_{e x p} < \frac{1}{f} \cdot \frac{1}{2} = 0.5 e - 6 [ s ] \qquad ( 17 )$$

Note that, here, an example of controlling an exposure time by modulating an LED being the light source 32 will be described.

In addition, the exposure control portion 54 of the controller 18 captures an image of gradient information of the surface S of the inspection object O, as an image I, with the number of pixels in an image captured by the light receiving portion 44a of the image sensor 44, being n×m (n and m are integers equal to or larger than 3), and an exposure time tₑₓₚ shorter than T/2. In this case, it is possible to capture the image I having a sharp shape and including no blurring, using the light receiving portion 44a of the image sensor 44. The number of pixels in a captured image is only required to satisfy λ/n>2 and λ/m>2, but by setting the number of pixels in such a manner as to satisfy λ/n≥10 and λ/m≥10, it is possible to capture the shape of a surface acoustic wave more clearly, which is preferable.

FIG. 6 illustrates an example of the image I acquired by the image sensor 44. In addition, FIG. 6 illustrates a positional relationship of the image I and the excitation element 24 (an excitation portion of a surface acoustic wave on the surface S of the inspection object O). In the present embodiment, in the image I within the image capturing range R on the surface S of the inspection object O, specularly-reflected light from the surface S is indicated in blue (B) color, scattering light at a certain angle θ2 is indicated in green (G) color, and scattering light at an angle θ3 larger than the angle θ2 is red (R) color. Because a region near a portion indicated by a broken line in FIG. 6 is close to red color, the signal processing portion 56 (the controller 18) can estimate that the region is a region in which an out-of-plane displacement occurs on the surface S of the inspection object O. In addition, because a region of a region between broken lines is close to blue color, the signal processing portion 56 (the controller 18) can estimate that the region is a region in which an out-of-plane displacement does not occur on the surface S of the inspection object O.

By measuring a distance between broken lines in FIG. 6, for example, the signal processing portion 56 of the controller 18 outputs the wavelength λ of one cycle T of the surface acoustic wave captured in an image. In addition, the signal processing portion 56 can calculate the velocity of surface acoustic waves from a distance between an input position of excitation vibration and an appropriate position of the image capturing range R, and a time lag between an input timing of excitation vibration and an exposure timing that is controlled by the synchronous control portion 52. In addition, as illustrated in FIGS. 19 and 21 of a second embodiment to be described later, the signal processing portion 56 can output an angle change amount of reflected light of the image capturing range R, from gradient information of the image capturing range R including surface acoustic waves. An amplitude of the surface acoustic wave and an out-of-plane displacement amount can also be output based on a space distribution of an angle change amount.

In this manner, the controller (information processing apparatus) 18 can calculate a feature amount of a surface acoustic wave based on gradient information (gradient information image I) of the surface S of the inspection object O serving as an elastic body. That is, the controller (information processing apparatus) 18 can calculate a feature amount of the surface acoustic wave based on direction information of light rays that corresponds to gradient information of the elastic body surface S of the inspection object O that is obtained when the surface acoustic wave is excited on the elastic body surface S of the inspection object O. The controller 18 can acquire direction information of light rays associated with colors. Note that the feature amount of the surface acoustic wave is not limited, but the feature amount preferably includes at least one of a wavelength, a cycle, a propagation velocity, a space distribution, an amplitude, and an out-of-plane displacement of the surface acoustic wave, for example.

In the image I illustrated in FIG. 6 that has been obtained by the information acquisition system 1 of an elastic body according to the present embodiment, intervals between three wavelengths λ are substantially the same interval, and include less irregularity. In this case, the signal processing portion 56 of the controller 18 can output information indicating that an internal defect or the like to be affected when a Lamb wave serving as a surface acoustic wave travels is highly likely to be non-existent in a region from a position at which the surface acoustic wave is excited, to the image capturing range R.

Note that, at a position indicated by the symbol B in the image I in FIG. 6, a region in which color partially changes is captured as an image. An image of the region B is generally captured as a green color region, and an image of the outer periphery of the region B is generally captured as a blue color region input as specularly-reflected light. Thus, the region B can be estimated to be a flaw, dirt, or the like on the surface S of the inspection object O. That is, the signal processing portion 56 of the controller 18 can estimate that a flaw, dirt, or the like exists on the surface S of the inspection object O.

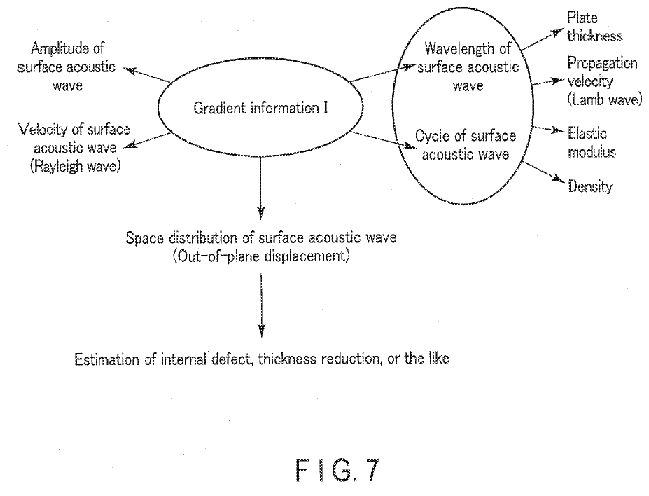

As illustrated in FIG. 7, the signal processing portion 56 of the controller 18 can obtain, from the gradient information image I, the wavelength λ of the surface acoustic wave, the cycle T of the surface acoustic wave, the velocity of the surface acoustic wave, an angle change amount (amplitude ratio) of the surface acoustic wave, or the like. The signal processing portion 56 can calculate, from such an image (gradient information image) I, a plate thickness, the propagation velocity of the surface acoustic wave, an elastic modulus, a density, and the like. In this case, the signal processing portion 56 can calculate an unknown density or the like from the image (gradient image) I acquired by exciting the surface acoustic wave.

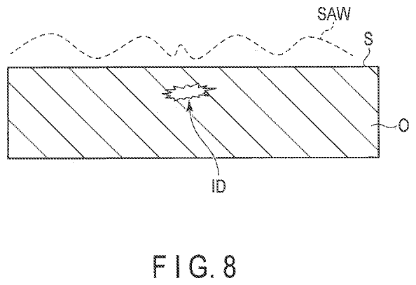

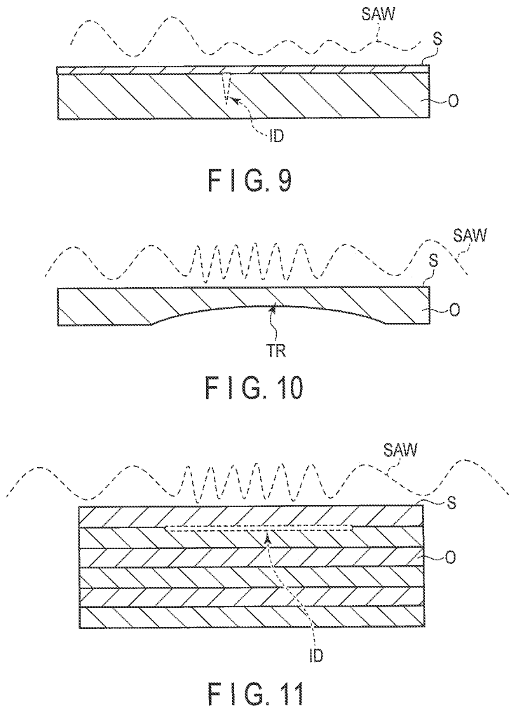

In addition, by acquiring a space distribution (out-of-plane displacement) of the surface acoustic wave, the controller 18 can estimate the existence or non-existence of an internal defect ID (refer to FIGS. 8 and 9) of a void portion or the like of the inspection object O, a thickness reduced portion TR (refer to FIG. 10), and delamination ID (refer to FIG. 11) or the like if the inspection object O is stacked in layers. The estimation of the existence or non-existence of the internal defect ID is not limited to a case where the inspection object O is formed of one material (base material) as illustrated in FIG. 8, and the controller 18 can estimate the existence or non-existence of the defect ID from the image I also in a case where a coating layer is formed on the base material as illustrated in FIG. 9, for example.

In a case where the internal defect ID exists in a region from an excitation position (sound source) of the surface acoustic wave on the surface S of the inspection object O to the inside of the image capturing range R, a medium in which the surface acoustic wave propagates changes from solid (for example, aluminum plate) to gas (air), for example, and changes again to solid. Thus, when the surface acoustic wave passes through a region in which the internal defect ID exists, a velocity at which the surface acoustic wave propagates changes. Accordingly, a propagation velocity varies between a surface acoustic wave that has reached the image capturing range R while a medium in which the surface acoustic wave propagates, remaining in solid entirely having uniform density, and a surface acoustic wave that has reached the image capturing range R by a medium in which the surface acoustic wave propagates, partially changing from solid to gas, for example, and changing again to solid, although the propagation velocity depends on the size and the depth of the internal defect ID. Accordingly, in a case where the internal defect ID exists in a region from an excitation position (sound source) of the surface acoustic wave to the inside of the image capturing range R, it is assumed that, in the image I captured within the image capturing range R, a position of a peak amplitude, for example, does not become a smoothly-continuing curved line or a straight line. Thus, by outputting the position of a peak amplitude, for example, by image recognition or the like, the signal processing portion 56 can determine irregularity of the surface acoustic wave, and estimate the existence of the internal defect ID. Accordingly, the controller 18 can estimate at least one of the existence or non-existence of damage to the inspection object O, the position of the damage, and the size of the damage, based on gradient information (the gradient information image I) of the surface S of the inspection object O serving as an elastic body.

Note that a penetration depth of the surface acoustic wave with respect to the surface S of the inspection object O varies depending on the wavelength λ. Thus, if a surface acoustic wave with a different frequency T (i.e., a surface acoustic wave with a different wavelength λ) is input to the surface S of the inspection object O from the excitation element 24, for example, the controller 18 can estimate a depth and a thickness of the internal defect ID with respect to the surface S of the inspection object O, and a depth at which the delamination ID occurs.

For example, if the excitation element 24 of the surface acoustic wave excitation portion 8 inputs a surface acoustic wave with an appropriate frequency (low frequency) lower than 1 MHz, for example, to the surface S of the inspection object O from the excitation element 24, the gradient information acquisition portion 16 can acquire the image I that can be affected by the internal defect ID at a deeper position, from the surface S of the inspection object O. In contrast, if the excitation element 24 of the surface acoustic wave excitation portion 8 inputs a surface acoustic wave with an appropriate frequency (high frequency) higher than 1 MHz, for example, to the surface S of the inspection object O from the excitation element 24, the gradient information acquisition portion 16 can acquire the image I that can be affected by the internal defect ID at a shallower position, from the surface S of the inspection object O.

Note that, in the present embodiment, like a sinusoidal wave illustrated in FIG. 1, a surface acoustic wave to be excited by the excitation element 24 has a plurality of cycles instead of one pulse. At this time, the excitation element 24 is driven based on a signal repeated at a frequency (first frequency) output by the signal generator 20. In this case, by setting an exposure time of one cycle as an exposure time tₑₓₚ, and synchronizing phases of an excitation signal of the surface acoustic wave to be excited by the excitation element 24, and an exposure timing, it is possible to repeat exposure of a plurality of cycles while the shutter of the image sensor 44 being opened. In this case, exposure is repeatedly performed N times (N: natural number) during one image capturing conducted by the image sensor 44. Accordingly, a cumulative exposure time of the image sensor 44 becomes N*tₑₓₚ. Even if the controller 18 controls the image sensor 44 in this manner, the controller 18 can obtain gradient information. for example, even in a case where image capturing is performed N times, the processing to be performed by the controller 18 at the time is performed in a shorter time because there is no need to perform other trials involving a change in an input position of an excitation signal of the surface acoustic wave and/or a change in a measurement position of the surface acoustic wave.

An exposure start timing of the image sensor 44 is controlled in accordance with an exposure start signal transmitted from the synchronous control portion 52, and exposure of the image sensor 44 is started. Image capturing may be repeatedly performed while regarding a flow from an exposure start of the image sensor 44 to the lapse of a predetermined exposure time as one image capturing. In this case, image capturing using the image sensor 44 may be repeated until a predefined predetermined number of times or until a predetermined time elapses, or image capturing using the image sensor 44 may be continued until an explicit stop command is input from the controller 18 or a host computer not illustrated in the drawing.

Note that the gradient information acquisition portion 16 of the information acquisition system 1 of an elastic body according to the present embodiment can capture an image of a state of the surface S inside an observation range R by exposing the image sensor 44 while illuminating the surface S of the inspection object O with illumination light from the light source 32 even in a state in which a signal is not input to the excitation element 24, and the surface acoustic wave is not excited on the surface S of the inspection object O. That is, the gradient information acquisition portion 16 can optically acquire gradient information (second gradient information) of an elastic body that is based on direction information of light rays from the object point OP on the elastic body surface S that is obtained in a case where a surface acoustic wave is not excited on the elastic body surface S. At this time, the controller 18 acquires direction information of light rays associated with colors. In a case where specularly-reflected light and scattering light are obtained in the image I acquired using the image sensor 44 in a state in which a surface acoustic wave is not excited on the surface S of the inspection object O, the signal processing portion 56 can estimate that a flaw or the like is generated within the surface S in the observation range R on the surface S of the inspection object O.

Then, the flaw on the surface S is cancelled by acquiring a difference (=I1−I2) between a gradient image I2 of second gradient information acquired without exciting a surface acoustic wave, and a gradient image I1 of first gradient information acquired in a state in which a surface acoustic wave is excited. Thus, the flaw on the surface S can be obtained from the image I2, and an internal damage or the like can be obtained from the difference (=I1− I2) between the images I1 and I2. Accordingly, the controller 18 of the information acquisition system 1 of an elastic body according to the present embodiment can separate a flaw on the surface S of the inspection object O, and internal damage or the like of the inspection object O. Accordingly, the controller 18 can acquire undersurface information of the elastic body surface S based on gradient information (first gradient information) acquired by exciting a surface acoustic wave, and gradient information (second gradient information) acquired without exciting a surface acoustic wave.

In the information acquisition system 1 of an elastic body according to the present embodiment, it is possible to map a color phase different from an angle of scattered light in an image (gradient information image) I captured in a certain image capturing region R, while causing a surface acoustic wave excited on an elastic body (the surface S of the inspection object O), to propagate. Thus, in the information acquisition system 1 of an elastic body according to the present embodiment, it is possible to acquire the property (cycle, amplitude, velocity, shape, distribution, or the like) of a surface acoustic wave on the surface (inspection range R) with a predetermined size in the surface S of the inspection object O, as the image (gradient information image) I by one shot, for example. Then, the information acquisition system 1 of an elastic body can detect a mechanical characteristic of the inspection object O and damages of the inspection object O from the property of the surface acoustic wave.

In the information acquisition system 1 of an elastic body according to the present embodiment, an example of using a Lamb wave mode that can occur in a case where a plate thickness is small, and a penetration depth of a surface acoustic wave is larger than the plate thickness with respect to the wavelength λ as the surface acoustic wave has been described. Also in the case of using a Rayleigh wave mode that can occur in a case where the thickness of the inspection object O is appropriately thickened, and a penetration depth of a surface acoustic wave is smaller than the plate thickness with respect to the wavelength λ as the surface acoustic wave, as mentioned above, information regarding an elastic body can be acquired.

In addition, because a surface acoustic wave is affected up to a depth nearly equal to its wavelength, by acquiring a gradient distribution while changing the wavelength λ or the frequency f of a surface acoustic wave to be excited, it becomes possible to detect a flaw for each depth. For example, in the case of using the Rayleigh wave mode, the surface acoustic wave excitation portion 8 may excite a surface acoustic wave while changing an excitation wavelength with time. In this case, by changing a frequency of a sinusoidal wave or the like to be input to the surface acoustic wave excitation portion 8, to an appropriate frequency, for example, it is possible to excite a surface acoustic wave with a different wavelength on the surface S of the inspection object O without changing the excitation element 24 of the surface acoustic wave excitation portion 8. Then, the controller 18 respectively acquires gradient information corresponding to a wavelength, using the image sensor 44. Thus, by acquiring, using the image sensor 44, gradient information for each wavelength penetrating at a different penetration depth from the surface S of the inspection object O, the controller 18 can acquire a depth of internal damage from the surface S of the inspection object O, for example.

In the conventional nondestructive inspection, for example, it is general to measure a surface acoustic wave as a “point” using an acoustic emission (AE) sensor, an acceleration sensor, laser Doppler measurement, or the like. To inspect the property of a surface acoustic wave as a “surface”, it is necessary to perform scanning of repeatedly performing surface acoustic wave excitation and measurement while moving a point. Thus, in the case of performing measurement of a surface acoustic wave by point input or point measurement in the conventional nondestructive inspection, there is such a problem that, if a measurement range is widened, a measurement time becomes longer. In addition, in the conventional nondestructive inspection, because a surface acoustic wave of a different trial is detected for each point, the state of an object might vary between start and end time points of measurement.

For example, in a case where the same region as an image capturing region R is to be inspected using the method of the conventional nondestructive inspection, an apparatus that measures a surface acoustic wave is required to be installed at each point, and it is assumed that a time taken from the install until the measurement is performed is at least ten seconds, for example. In a case where this work is performed for several thousands of points, it is assumed that it takes ten thousands of seconds or more. In contrast to this, in the case of inspecting an elastic body using the information acquisition system 1 of an elastic body according to the present embodiment, only about 0.005 seconds is taken from when a surface acoustic wave is excited on the surface S of the inspection object O, until the light receiving portion 44a of the image sensor 44 ends the acquisition of the image I including the number of pixels (for example, 20000000 pixels) of the light receiving portion 44a. In the case of performing inspection using the information acquisition system 1 of an elastic body according to the present embodiment, there is an advantage not only in measurement velocity but also in the number of measurement points. Accordingly, by using the information acquisition system 1 of an elastic body according to the present embodiment, it is possible to measure a predetermined range not as a point but as a surface in a short time. Accordingly, by the information acquisition system 1 of an elastic body according to the present embodiment, it becomes possible to acquire the property of a surface acoustic wave easily and two-dimensionally, and it is possible to drastically reduce an inspection time as compared with the case of inspecting a plurality of points by different trials.

Note that, even in a case where an image is acquired a plurality of times, by using the information acquisition system 1 of an elastic body according to the present embodiment, there is no need to move a vibration excitation position and the observation range R. Thus, it is possible to process or acquire information regarding an elastic body including a surface with an appropriate size, in a shorter time.

Furthermore, it is possible to acquire the property of a surface acoustic wave propagating on the surface with a predetermined size in the surface S of the inspection object O, by one shot using the information acquisition system 1 of an elastic body according to the present embodiment, at all points (pixels of the light receiving portion 44a of the image sensor 44) without time delay, and output the property as one image, and improve the reliability of a measurement result because the measurement in a different trial is unnecessary.

Note that, as mentioned above, in a case where the controller 18 causes the surface acoustic wave excitation portion 8 to excite a surface acoustic wave by changing an excitation wavelength with time, the controller 18 acquire, using the image sensor 44, gradient information corresponding to a wavelength (direction information of light rays). Also in this case, the controller 18 can obtain gradient information of the image capturing range R by one shot in each wavelength. Thus, even in a case where desired information of an elastic body cannot be obtained by one shot, the information acquisition system 1 of an elastic body according to the present embodiment can acquire information regarding an elastic body including a surface with an appropriate size, in a shorter time.

In addition, the gradient information acquisition portion 16 of the information acquisition system 1 of an elastic body can acquire the image I as gradient distribution of a region R in which the wavelength λ can be read. Thus, the controller 18 of the information acquisition system 1 can accurately calculate the wavelength λ from the image I. For example, the gradient information acquisition portion 16 can map an arbitrary color phase in an image of a region R in accordance with a scattering angle of an illuminated surface on the surface S of the elastic body. Then, the gradient information acquisition portion 16 of the information acquisition system 1 of an elastic body is proposed as a one-shot image capturing optical system that can acquire information regarding an elastic body, as a color image corresponding to gradient distribution of the region R, and is preferable for this method.

In the present embodiment, the wavelength selection regions 46a, 46b, and 46c of the multiwavelength aperture 46 are arranged in order from the central part outward in a radial direction in such a manner as to pass through light in blue, green, and red wavelengths. It is also preferable that the wavelength selection regions 46a, 46b, and 46c of the multiwavelength aperture 46 are arranged in order from the central part outward in the radial direction in such a manner as to pass through light in red, green, and blue wavelengths. Here, an example in which the multiwavelength aperture 46 includes the three wavelength selection regions 46a, 46b, and 46c has been described, but wavelength selection regions may be arranged in order from the central part outward in the radial direction in such a manner as to pass through light in blue and red wavelengths, or may be arranged in order in such a manner as to pass through light in red and blue wavelengths, for example. Thus, the number of wavelength selection regions of the multiwavelength aperture 46 may be two. In this case, it is preferable to use red (R) light and blue (B) light having distant ranges of wavelengths of light to be passed through.

In addition, the central part of the multiwavelength aperture 46 may be shielded in such a manner as to block light in all wavelengths. Then, in the multiwavelength aperture 46, a region that passes through red light, for example, is formed in the outer periphery of the central part. In this case, because specularly-reflected light is blocked, light is not received by the light receiving portion 44a of the image sensor 44. A pixel that specularly-reflected light intended to enter becomes black color, for example. On the other hand, scattering light having a predetermined scattering angle is received by the light receiving portion 44a of the image sensor 44 through the region of the multiwavelength aperture 46 that passes through red light, for example. In this case, as mentioned above, a difference lies only in that the central part passes through blue light or passes through no light. Accordingly, the multiwavelength aperture 46 may be a multiwavelength aperture in which one wavelength selection region of red light or the like, for example, is provided on the outer periphery of the central part.

By using the information acquisition system 1 of an elastic body according to the present embodiment, it is possible to acquire, as an image, the property (cycle, amplitude, velocity, shape, distribution) of a surface acoustic wave propagating on a surface (image capturing region R) with a predetermined size in the surface S of the inspection object O, in a shorter time such as by one shot. That is, it is possible to obtain the property of the surface S and the inside of an elastic body that reflects a penetration depth corresponding to a frequency of a surface acoustic wave, by short-time image capturing such as one shot. At this time, using the image sensor 44, it is possible to acquire the property of a surface acoustic wave easily as a two-dimensional or three-dimensional image. Thus, by using the information acquisition system 1 of an elastic body according to the present embodiment, it is possible to drastically reduce an inspection time as compared with the case of inspecting a plurality of points by different trials.

Accordingly, according to the present embodiment, it is possible to provide an information processing apparatus (the controller 18), the information acquisition apparatus 10 of an elastic body, the information acquisition system 1 of an elastic body, an information acquisition method of an elastic body, and a non-transitory storage medium storing an information acquisition program of an elastic body that can process or acquire information regarding an elastic body including a surface with an appropriate size (image capturing region R), in a shorter time such as by one shot.

### Modified Example

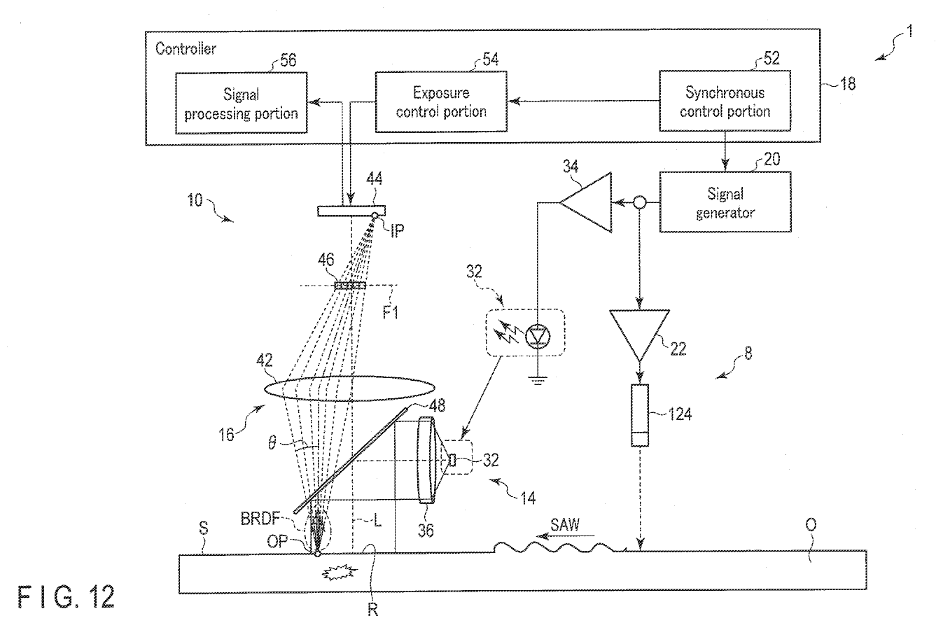

The information acquisition system 1 of an elastic body according to a modified example of the first embodiment will be described using FIG. 12.

Here, the inspection object O is assumed to be an aluminum plate having a plate thickness of 1 mm, for example. In addition, here, reflective waves from an edge of the inspection object O are not considered. The surface acoustic wave excitation portion 8 is assumed to use a laser-driven apparatus 124 in place of the excitation element 24 and the wedge 26. A YAG laser, a semiconductor laser, or the like can be used as the laser-driven apparatus 124. In a case where the laser-driven apparatus 124 is used, unlike the excitation element 24 and the wedge 26, the laser-driven apparatus 124 is arranged in a contactless manner with respect to the inspection object O.

Note that the acquisition of surface acoustic wave information (gradient information) of the information acquisition system 1 of an elastic body can be performed through the same flow as that in the flowchart of the first embodiment that is illustrated in FIG. 5.

A signal generator (waveform generator) 20 generates a pulse signal using an arbitrary waveform generator (step ST1).

The laser-driven apparatus 124 excites a Lamb wave on the inspection object O while illuminating the surface S of the inspection object O with laser light (step ST2).

The light source 32 is caused to emit light in such a manner that an image of an out-of-plane displacement can be captured within the image capturing range R, in accordance with the propagation velocity of a Lamb wave serving as a surface acoustic wave, from the time when the laser-driven apparatus 124 emits laser light onto the surface S of the inspection object O, and the light receiving portion 44a of the image sensor 44 is exposed (step ST3).

Then, the image sensor 44 controlled by the controller 18 acquires an image (gradient information image) related to gradient information of the image capturing range R, and outputs image information to the signal processing portion 56 (step ST4).

Note that, as illustrated in FIG. 4, a propagation velocity is preliminarily estimated from relationship between frequency and wavelength of the Lamb wave that is obtained by the emission of laser light onto the 1 mm-thickness aluminum plate.

The signal processing portion 56 calculates at least any one of a wavelength, a cycle, an amplitude, and a velocity of the surface acoustic wave based on the gradient information image captured by the gradient information acquisition portion 16.

Accordingly, according to this modified example, it is possible to provide an information processing apparatus (the controller 18), the information acquisition apparatus 10 of an elastic body, the information acquisition system 1 of an elastic body, an information acquisition method of an elastic body, and a non-transitory storage medium storing an information acquisition program of an elastic body that can process or acquire information regarding an elastic body including a surface with an appropriate size (image capturing region R), in a shorter time such as by one shot.

Note that, also in the case of using a Rayleigh wave mode that can occur in a case where the thickness of the inspection object O is appropriately thickened, and a penetration depth of a surface acoustic wave is smaller than the plate thickness with respect to the wavelength λ as the surface acoustic wave, information regarding an elastic body can be acquired using the information acquisition system 1 of an elastic body according to this modified example.

### Second Embodiment

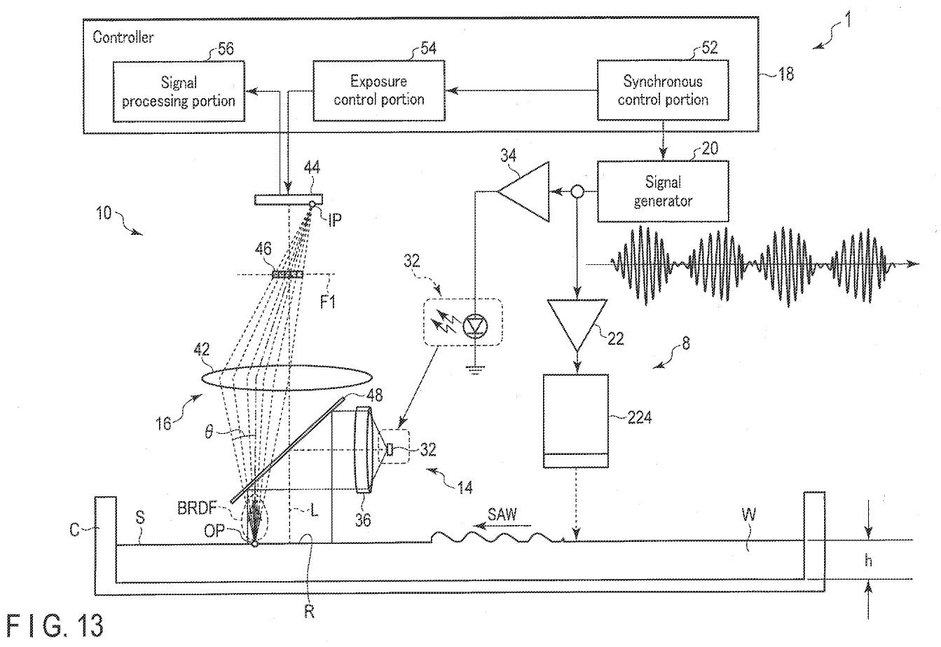

An information acquisition system 1 of an elastic body according to the second embodiment will be described using FIGS. 13 to 21.

The information acquisition system 1 of an elastic body is basically formed similarly to the information acquisition system 1 of an elastic body according to the first embodiment.

As illustrated in FIG. 13, in the second embodiment, an example in which the inspection object O is water W, for example, among various types of liquid will be described. The water W is stored in a tank C. A water depth h of the water W in the tank C is 5 mm, for example. In addition, here, reflective waves from the tank C storing the inspection object O are not considered. In the present embodiment, the surface acoustic wave excitation portion 8 uses an excitation element 224 in place of the excitation element 24 (and the wedge 26) described in the first embodiment. The excitation element 224 uses an airborne ultrasound element with a resonance frequency of 200 kHz, for example.

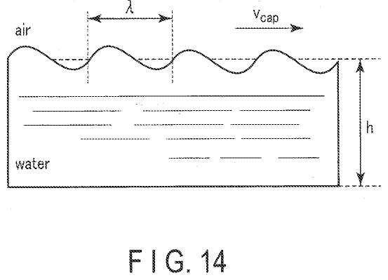

Here, a surface acoustic wave (capillary-gravity wave) to be excited on the surface of liquid will be described. FIG. 14 illustrates a propagation state of a surface acoustic wave at a velocity v_{cap} in a case where liquid is water and gas is air. At this time, a water depth is denoted by h and a wavelength is denoted by A.

Because surface tension and weight act as restoring force on a surface acoustic wave excited on the surface of liquid, the surface acoustic wave is called a capillary-gravitational wave. In accordance with the magnitude of the wavelength λ with respect to the water depth, when the wavelength is large, a gravitational wave becomes dominant, and when the wavelength is small, a capillary wave becomes dominant. If a density ρ_{w} of liquid, a density ρₐᵢᵣ of gas, a gravitational force g, a surface tension σ, and a depth h of liquid are set, a propagation velocity v_{cap} and a wavenumber k (=2π/λ) satisfy a velocity dispersion relationship represented by the following formula (18).

$${v}_{c a ρ} = \sqrt{( \frac{{ρ}_{w} - {ρ}_{air}}{{ρ}_{w} + {ρ}_{air}} ) ( \frac{g}{k} + \frac{σ k}{{ρ}_{w} - {ρ}_{air}} ) tanh ( k h )} \qquad ( 18 )$$

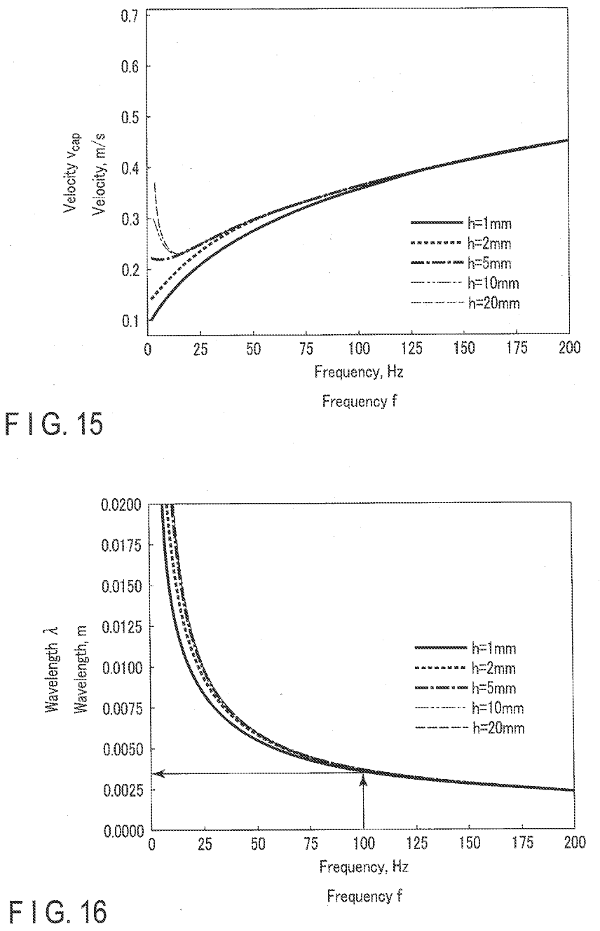

FIG. 15 illustrates relationship between frequency and velocity that is obtained in a case where liquid is water and gas is air, and a water depth is varied like 1 mm, 2 mm, 5 mm, 10 mm, and 20 mm, and FIG. 16 illustrates relationship between frequency and wavelength. As an example, it can be seen that, in a case where the frequency is 30 Hz, the wavelength becomes about 8.7 mm, and in a case where the frequency is 40 Hz, the wavelength becomes about 6.9 mm.

Note that the acquisition of surface acoustic wave information (gradient information) of the information acquisition system 1 of an elastic body can be performed through the same flow as that in the flowchart of the first embodiment that is illustrated in FIG. 5.

As mentioned above, the water depth h in the tank C is assumed to be 10 mm. According to the theory of surface acoustic waves of liquid, it can be seen that a wavelength of a surface acoustic wave excited by the excitation element 224 can be estimated to be 10 mm or less, and in this case, the surface acoustic wave is a capillary wave having surface tension as restoring force.

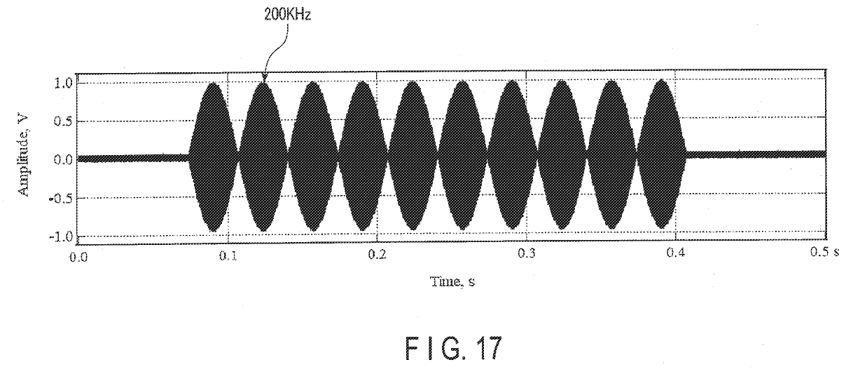

Using an arbitrary waveform generator, the signal generator 20 has generated an excitation signal at 1 Vpp obtained by amplitude-modulating a sinusoidal wave with a carrier frequency of 200 kHz, at a predetermined modulation frequency f_{mod} that is illustrated in FIG. 17 (ST1). As the carrier frequency (first frequency f1) becomes higher, it becomes easier to obtain directionality, and the carrier frequency is desirably 10 kHz or more. The modulation frequency f_{mod} (second frequency f2) is desirably 1000 Hz or less from such a viewpoint that amplitude can be sufficiently ensured. In addition, by using double side band suppressed carrier (DSB-SC) modulation as amplitude modulation, it becomes possible to excite a surface acoustic wave with an intended frequency, without exciting an unnecessary high-frequency component.

As a carrier signal C(t), a modulation signal M(t), and an excitation signal A(t), signals respectively represented by the following formulae (19), (20), and (21) if an angle frequency ω_{ca} of the carrier signal, an angle frequency amplitude β of the modulation signal, and a modulation strength k are set are used.

C(t)=cos(ω_{ca}t) (19)

M(t)=k·cos(ω_{mod}t)(t) (20)

A(t)=C(t)M(t) (21)

In this case, a sound pressure P(t) to be generated is represented by the following formula (22) using a constant α.

P(t)=αA(t)=αC(t)M(t) (22)

Energy E(t) to be produced is represented by the following formula (23) as the density p of gas and a sound velocity c.

$$\begin{matrix}E ( t ) = \frac{{P}^{2}}{ρ c} = \frac{{α}^{2} {k}^{2}}{ρ c} \cdot {cos}^{2} ( {ω}_{c a} t ) \cdot {cos}^{2} ( {ω}_{m o d} t ) \\ = \frac{{α}^{2} {k}^{2}}{ρ c} \cdot \frac{1}{4} \{ 1 + cos 2 {ω}_{m o d} t + cos 2 {ω}_{c a} t \cdot ( 1 + cos 2 {ω}_{m o d} t ) \}\end{matrix} \qquad ( 23 )$$

If a time average in a short time is calculated, a term related to the carrier frequency disappears, and an average energy <E(t)> can be represented by Formula (24).

$$〈 E ( t ) 〉 = \frac{{a}^{2} {k}^{2}}{4 ρ c} \cdot ( 1 + cos 2 {ω}_{m o d} t ) \qquad ( 24 )$$

Thus, it can be seen that, in the present embodiment, a surface acoustic wave having a doubled frequency of the modulation frequency f_{mod} is excited on the water surface. That is, in a case where the modulation frequency f_{mod} is 30 Hz, a frequency of a surface acoustic wave to be excited becomes 60 Hz, and in a case where the modulation frequency f_{mod} is 40 Hz, a frequency of a surface acoustic wave to be excited becomes 80 Hz.

The amplifier 22 amplifies voltage to 50 to 150 times, for example, and applies the voltage to the excitation element 224. The excitation element 224 is arranged at a position separated from the water surface by about 10 mm. By such a system, it is possible to excite a surface acoustic wave having a doubled frequency of the modulation frequency f_{mod}, on the water surface (ST2).

The exposure control portion 54 controls an exposure start timing and an exposure time tₑₓₚ of the gradient information acquisition portion 16 for the image sensor 44. For example, tₑₓₚ=0.01 [s] is set in such a manner as to satisfy Formula (25) in a case where the modulation frequency f_{mod}=30 Hz is set.

$${t}_{e x p} < \frac{1}{f} \cdot \frac{1}{2} = 0.0 \; 167 [ s ] \qquad ( 25 )$$

The synchronous control portion 52 outputs an excitation start signal for commanding a start timing of an excitation operation of the surface acoustic wave excitation portion 8, and an exposure start signal commanding a timing at which the exposure control portion 54 starts exposure.

The controller 18 causes the light source 32 to emit light and exposes the light receiving portion 44a of the image sensor 44, in such a manner that the image sensor 44 can acquire an image of an out-of-plane displacement within the image capturing range R, in accordance with the propagation velocity of a surface acoustic wave, from the time when the excitation element 224 emits light onto the water surface being the surface S of the inspection object O (ST3).

Then, the image sensor 44 controlled by the controller 18 acquires an image (gradient information image) related to gradient information of the image capturing range R, and outputs image information to the signal processing portion 56 (ST4).

The signal processing portion 56 calculates at least any one of a wavelength, a cycle, an amplitude, a velocity, a space distribution, an amplitude, and an out-of-plane displacement of the surface acoustic wave based on the gradient information (direction information of light rays) image captured by the gradient information acquisition portion 16. Furthermore, from relationship between frequency and wavelength, based on a theoretical formula, at least one of a density of liquid, a density of gas, gravitational force, surface tension, and a thickness of liquid is calculated.

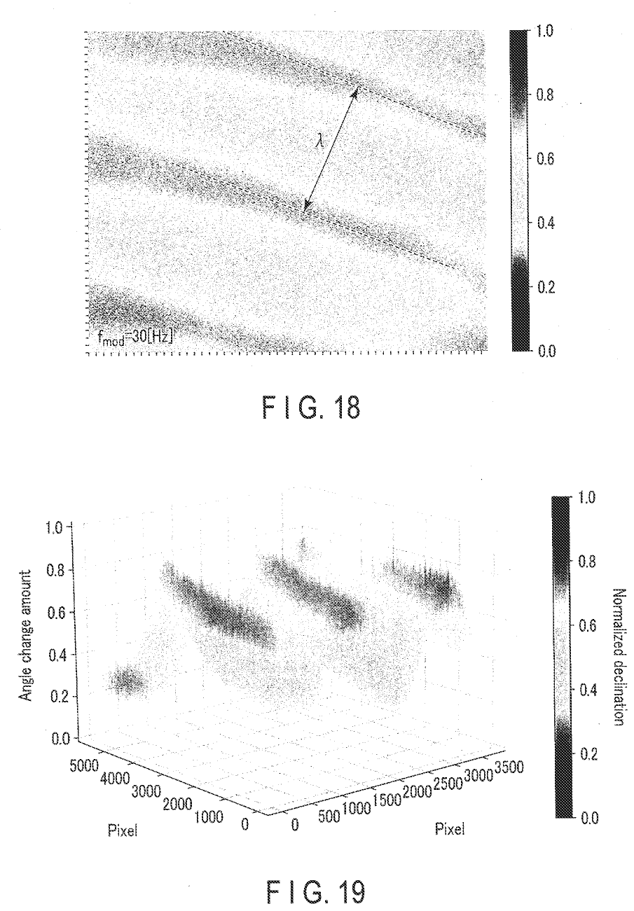

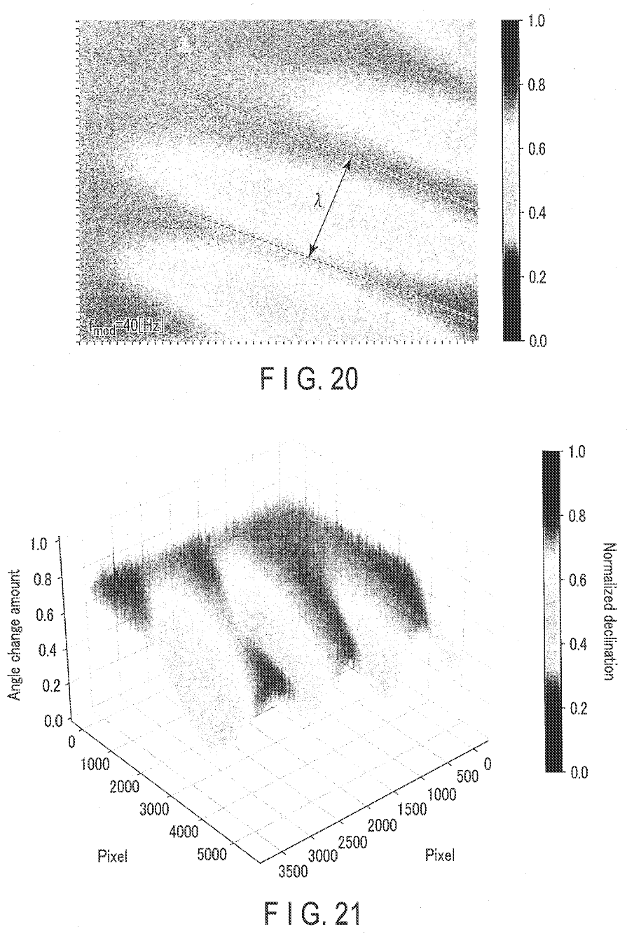

FIGS. 18 and 19 illustrate an actual measurement result obtained by calculating a space distribution in a case where a surface acoustic wave is excited with the modulation frequency f_{mod} of 30 Hz, and FIGS. 20 and 21 illustrate an actual measurement result obtained by calculating a space distribution in a case where a surface acoustic wave is excited with the modulation frequency f_{mod} of 40 Hz.

FIGS. 18 and 20 illustrate the image I obtained by capturing an image of the surface S including an out-of-plane displacement of a surface acoustic wave propagating in the image capturing range R of the inspection object O, using the light receiving portion 44a of the image sensor 44. From the relationship between the size of the image capturing range R on the surface S of the inspection object O and the light receiving portion 44a of the image sensor 44, a distance can be obtained in the image I. On the image I illustrated in FIG. 18, a red-color region and a blue-color region exist like streaks. An interval between red-color regions is a substantially-equal interval. In the present embodiment, the signal processing portion 56 (the controller 18) can estimate that a red-color region is a region in which an out-of-plane displacement occurs on the surface S of the inspection object O. In addition, the signal processing portion 56 (the controller 18) can estimate that a blue-color region is a region in which an out-of-plane displacement does not occur on the surface S of the inspection object O. By measuring a distance between (centers) of red-color regions in FIG. 18, for example, the signal processing portion 56 of the controller 18 outputs the wavelength λ of one cycle T of the surface acoustic wave captured in the image I. In addition, the signal processing portion 56 can calculate the velocity of a surface acoustic wave.

In addition, as illustrated in FIG. 19, the gradient information image I acquired by the gradient information acquisition portion 16 when a surface acoustic wave passes through the image capturing range R includes angle information from the object point OP. That is, specularly-reflected light image-captured as blue color is parallel to the optical axis L, and θ1≈0° is set. Scattering light having an angle within a range of an angle θ2>θ1 (≈0°) with respect to the optical axis L that is to be image-captured as green color, and scattering light having an angle within a range of an angle θ3>θ2 with respect to the optical axis L that is to be image-captured as red color are acquired using the image sensor 44. Thus, a deflection angle can be output for each pixel by setting angle θ1≈0° to 0, angle θ2=0.5, and angle θ3=1, for example. Thus, as angle information in each pixel, an angle parallel to the optical axis is set to 0°, and (0°≈) θ1<θ2<θ3 is set. An angle amplitude ratio can be output.

In addition, FIGS. 19 and 21 illustrate images of color obtained in longitudinal and transverse pixels of a substantially-rectangular shape of the image sensor 44 in the image capturing range R, and vertical axis indicates a gradient angle θ with respect to the optical axis L as an angle change amount. As the angle θ illustrated in FIGS. 19 and 21 gets closer to 1, a scattering angle becomes larger and color gets closer to red (R), and as the angle θ gets closer to 0, color gets closer to blue (B) obtained by capturing specularly-reflected light. Based on FIGS. 19 and 21, it is also possible to reconstruct a three-dimensional image obtained by capturing an image of the surface S including an out-of-plane displacement of a surface acoustic wave propagating in the image capturing range R of the inspection object O, using the light receiving portion 44a of the image sensor 44.

Then, the signal processing portion 56 can calculate, from such an image (gradient image) I, a water depth, the propagation velocity of the surface acoustic wave, an elastic modulus, a density, and the like.

In the present embodiment, an example of using the water W as the inspection object O has been described, but aside from water, various types of water solution, blood, or the like can be used as the inspection object O. In this case, the signal processing portion 56 can calculate an unknown density or the like from the image (gradient image) I acquired by exciting the surface acoustic wave.

In this manner, the controller (information processing apparatus) 18 can calculate a feature amount of a surface acoustic wave based on gradient information of the surface (water surface) S of the inspection object O serving as an elastic body (i.e., direction information of light rays) (gradient information image I).

By using the information acquisition system 1 of an elastic body according to the present embodiment, it is possible to acquire, as an image related to gradient information (direction information of light rays), the property (cycle, amplitude, velocity, shape, distribution) of a surface acoustic wave propagating on a surface (image capturing region R) with a predetermined size in the surface S of the inspection object O, in a shorter time such as by one shot. Then, the information acquisition system 1 of an elastic body can obtain an image related to gradient information, by short-time image capturing such as one shot. At this time, using the image sensor 44, it is possible to acquire the property of a surface acoustic wave easily as a two-dimensional or three-dimensional image. Thus, by using the information acquisition system 1 of an elastic body according to the present embodiment, it is possible to drastically reduce an inspection time as compared with the case of inspecting a plurality of points by different trials.

Accordingly, according to the present embodiment, it is possible to provide an information processing apparatus (the controller 18), the information acquisition apparatus 10 of an elastic body, the information acquisition system 1 of an elastic body, an information acquisition method of an elastic body, and a non-transitory storage medium storing an information acquisition program of an elastic body that can process or acquire information regarding an elastic body including a surface with an appropriate size (image capturing region R), in a shorter time such as by one shot.

Accordingly, according to at least one embodiment mentioned above, it is possible to provide an information processing apparatus (the controller) 18, the information acquisition apparatus 10 of an elastic body, the information acquisition system 1 of an elastic body, an information processing apparatus, an information acquisition method of an elastic body, and a non-transitory storage medium storing an information acquisition program of an elastic body that can process or acquire information regarding an elastic body including a surface with an appropriate size, in a shorter time such as by one shot.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a controller configured to calculate a feature amount of a surface acoustic wave, based on direction information of a light ray that corresponds to gradient information of an elastic body surface of an inspection object that is obtained in a case where the surface acoustic wave is excited on the elastic body surface of the inspection object.

2. The information processing apparatus according to claim 1, wherein the controller is configured to:
associate colors with the direction information of the light ray, and
acquire the direction information of the light ray.

3. The information processing apparatus according to claim 1, wherein the feature amount of the surface acoustic wave includes at least one of a wavelength, a cycle, a propagation velocity, a space distribution, an amplitude, and an out-of-plane displacement of the surface acoustic wave.

4. The information processing apparatus according to claim 1, wherein the controller is configured to calculate at least one of a plate thickness, a propagation velocity, an elastic modulus, and a density of solid serving as an elastic body including the elastic body surface, based on a relationship between a frequency and a wavelength of the surface acoustic wave that is to be acquired from the gradient information of the elastic body surface.

5. The information processing apparatus according to claim 1, wherein the controller is configured to estimate at least one of existence or non-existence of damage to an elastic body including the elastic body surface, a position of damage, and a size of damage, based on the gradient information of the elastic body surface.

6. The information processing apparatus according to claim 1, wherein the controller is configured to calculate at least one of a density of liquid serving as an elastic body including the elastic body surface, a density of gas, gravitational force, surface tension, and a thickness of liquid, based on a relationship between a frequency and a wavelength of the surface acoustic wave that is to be acquired from the gradient information of the elastic body surface.

7. The information processing apparatus according to claim 1, wherein the controller comprises:
an exposure control portion configured to control exposure of an image sensor configured to acquire the gradient information of the elastic body surface; and
a synchronous control portion configured to output an excitation start signal and an exposure start signal,
the excitation start signal being a signal for starting excitation of the surface acoustic wave in a surface acoustic wave excitation portion configured to excite the surface acoustic wave on the elastic body surface, and
the exposure start signal being a signal for starting exposure of the image sensor, with a predetermined time lag that is based on a propagation velocity of the surface acoustic wave.

8. An information acquisition apparatus of an elastic body, the information acquisition apparatus comprising:
the information processing apparatus according to claim 1; and
a gradient information acquisition portion configured to optically acquire the direction information of the light ray that corresponds to the gradient information obtained in a case where the surface acoustic wave is excited on the elastic body surface of the inspection object.

9. The information acquisition apparatus according to claim 8, wherein:
the gradient information acquisition portion is configured to optically acquire second gradient information of the elastic body that is based on direction information of a light ray from the elastic body surface that is obtained in a case where the surface acoustic wave is not excited on the elastic body surface, and
the controller is configured to acquire undersurface information of the elastic body surface based on the gradient information and the second gradient information.

10. The information acquisition apparatus according to claim 8, wherein:
the gradient information acquisition portion comprises an image sensor configured to set an image capturing range with a circular region having at least a diameter λ or more, on the elastic body surface in a case where a wavelength of the surface acoustic wave that is obtained in a case where the surface acoustic wave is excited on the elastic body surface of the inspection object is denoted by A, and a cycle is denoted by T,
the number of pixels in an image captured within the image capturing range of the image sensor is n×m (n and m are integers equal to or larger than 3), and
the controller is configured to control the image sensor, and acquire the gradient information of the elastic body as an image by setting an exposure time of the image sensor to a time shorter than T/2.

11. The information acquisition apparatus according to claim 8, comprising a light source portion configured to emit illumination light being parallel light, onto the elastic body surface,
wherein:
the gradient information acquisition portion comprises:
a diaphragm including a first wavelength selection region; and
an image sensor configured to capture an image of light passing through the first wavelength selection region at a deflection angle from the elastic body surface, and
the controller is configured to calculate a deflection angle of a wavelength of the light based on a wavelength of light image-captured by the image sensor.

12. An information acquisition system of an elastic body, the information acquisition system comprising:
the information acquisition apparatus of the elastic body according to claim 8; and
a surface acoustic wave excitation portion configured to excite the surface acoustic wave on the elastic body surface.

13. The information acquisition system according to claim 12, wherein:
the surface acoustic wave excitation portion comprises:
a signal generator to be controlled by the controller, and
a surface acoustic wave excitation element configured to excite the surface acoustic wave based on a signal generated by the signal generator, and
the surface acoustic wave excitation element is driven based on a signal repeating at a first frequency that is output from the signal generator while being controlled by the controller.

14. The information acquisition system according to claim 13, wherein:
the surface acoustic wave excitation element comprises at least any of a piezoelectric element, a laser light source, a speaker, and an electromagnetic acoustic wave element, in a case where the elastic body is solid, and
the surface acoustic wave excitation element is configured to excite a Rayleigh wave or a Lamb wave on the inspection object as the surface acoustic wave.

15. The information acquisition system according to claim 13, wherein:
the surface acoustic wave excitation element comprises an airborne ultrasound element, in a case where the elastic body is liquid, and
the surface acoustic wave excitation element is configured to excite at least either one of a capillary wave or a gravitational wave on the inspection object as the surface acoustic wave.

16. The information acquisition system according to claim 12, wherein:
the surface acoustic wave excitation portion comprises:
a signal generator to be controlled by the controller, and
a surface acoustic wave excitation element configured to excite the surface acoustic wave based on a signal generated by the signal generator, and
the surface acoustic wave excitation element is driven based on a signal obtained by amplitude-modulating a signal repeating at a first frequency f1 that is output from the signal generator while being controlled by the controller, at a second frequency f2 lower than the first frequency.

17. The information acquisition system according to claim 16, wherein:
the first frequency f1 satisfies f1≥10 kHz, and
the second frequency f2 satisfies f2≤1000 Hz.

18. The information acquisition system according to claim 12, wherein:
the surface acoustic wave excitation portion is configured to excite the surface acoustic wave with an excitation wavelength changed with time, and
the controller is configured to detect internal damage based on the gradient information of each of the excitation wavelengths.

19. An information acquisition method of an elastic body, the information acquisition method comprising:
optically acquiring gradient information of an elastic body surface of an inspection object that is obtained in a case where the surface acoustic wave is excited on the elastic body surface of the inspection object; and
calculating a feature amount of the surface acoustic wave based on direction information of a light ray that corresponds to the gradient information of the elastic body surface.

20. The information acquisition method according to claim 19, wherein the acquiring the gradient information comprises:
setting, as an image capturing range, a region including a circular region having at least a diameter λ or more of the elastic body surface set by an image sensor in a case where a wavelength of the excited surface acoustic wave is denoted by A, and a cycle is denoted by T;
acquiring an image of the image capturing range as an image;
setting the number of pixels in an image captured within the image capturing range of the image sensor to n×m (n and m are integers equal to or larger than 3); and
acquiring the gradient information of the elastic body as an image by setting an exposure time of the image sensor to a time shorter than T/2.

21. The information acquisition method according to claim 19, wherein the acquiring the gradient information comprises,
adjusting:
an excitation timing of the surface acoustic wave in a case of being excited on the elastic body surface;
an exposure timing of an image sensor; and
a light emission light onto the elastic body surface.

22. A non-transitory storage medium storing an information acquisition program of an elastic body that causes a computer to execute:
acquiring gradient information of an elastic body surface of an inspection object that is obtained in a case where the surface acoustic wave is excited on the elastic body surface of the inspection object; and
calculating a feature amount of the surface acoustic wave based on direction information of a light ray that corresponds to the gradient information of the elastic body surface.
